(19) United States
(12) Patent Application Publication
(10) Pub. No.: US 2021/0016454 A1
(43) Pub. Date: Jan. 21, 2021

(54) CONTROL OF MODULAR END-OF-ARM TOOLING FOR ROBOTIC MANIPULATORS

(71) Applicant: Kindred Systems Inc., San Francisco, CA (US)

(72) Inventors: Jun Jeong, San Francisco, CA (US); Sara Wojciechowski, San Francisco, CA (US); Nicholas Keyes, Saratoga, CA (US); Cindy Yeh, San Francisco, CA (US); Ryan Dick, Toronto (CA); Jun Song, Toronto (CA); Kevin George, San Francisco, CA (US); Adrian Martin, Toronto (CA); Bryan Whittington, San Francisco, CA (US); Julian Villella, Toronto (CA); Stefan Wiechula, Toronto (CA); David Gabriel Hallock, San Francisco, CA (US)

(21) Appl. No.: 16/931,232

(22) Filed: Jul. 16, 2020

Related U.S. Application Data
(60) Provisional application No. 62/874,721, filed on Jul. 16, 2019.

(51) Int. Cl. B25J 15/00; B23Q 7/04; B25J 15/06

(52) U.S. Cl. CPC B25J 15/0061; B25J 15/0616; B23Q 7/043; B23Q 7/046

(57) ABSTRACT

A tool changer at a distal end of a robotic arm may include a proximal engagement plate and a tool may include a distal engagement plate magnetically engaged with the proximal engagement plate. The tool changer may be configured to magnetically engage and disengage with a variety of tools as different tools are needed for operations being performed by the robotic arm. Decisions regarding which tools to couple to the tool changer may be made on-the-fly and based on changing circumstances as the robotic arm is used to operate on objects.

### BACKGROUND

### Technical Field

The present disclosure relates to robotic manipulators and, more specifically, to modular end-of-arm tooling systems for robotic manipulators, and to methods and system for control thereof.

### Description of the Related Art

Automated robotics, conveyors, and other motive devices are used in many industrial or logistic applications to sort, relocate, convey, or otherwise manipulate objects in order to achieve a desired goal. All of the objects in certain industrial or logistical operations may be of the same type such that the same destination or operation is applicable to each object involved. In postal services, for example, sorting machines process letters and parcels via recognition of optical characters thereon and imprint each processed item of mail with a corresponding barcode indicating a destination for the respective processed item of mail. The operation to be performed for each object is therefore predetermined and the process may be easily automated.

In some situations, automated processing of a collection of objects remains a complex and difficult challenge. Consider a scenario in which a collection of objects are assembled that include different object types and each object type is to be processed differently than other object types. In a manufacturing operation, a collection of objects (e.g., shipment) may be received that includes a uniform collection of components of the same type. In other scenarios, a collection of objects may be received that includes different object types, each object type to be processed differently than the other object types. Thus, tool changers for robotic arms have been developed.

### BRIEF SUMMARY

A method may be summarized as comprising: receiving a set of objects within a workspace of a robotic arm; collecting information regarding the set of objects, the information including characteristics of individual objects in the set of objects; determining, based on the collected information and the characteristics of the individual objects, a first optimal order in which to operate on the set of objects, the first optimal order specifying at least a first pick of the first optimal order and a second pick of the first optimal order to be performed after the first pick of the first optimal order; performing the first pick of the first optimal order; after performing the first pick of the first optimal order and before performing the second pick of the first optimal order, collecting additional information regarding the set of objects, the additional information including updated characteristics of individual objects in the set of objects; determining, based on the additional collected information and the updated characteristics of the individual objects, a second optimal order in which to operate on the set of objects, the second optimal order specifying at least a first pick of the second optimal order to be performed after the first pick of the first optimal order, wherein the second optimal order is different than a remaining portion of the first optimal order; and performing the first pick of the second optimal order.

The characteristics of the individual objects in the set of objects may include an object type of the individual objects, dimensions of the individual objects, locations of the individual objects, orientations of the individual objects, and/or rigidities and porosities of the individual objects. Determining the first optimal order in which to operate on the set of objects may include determining a first optimal order in which to use each of a plurality of different tools coupled to a distal end of the robotic arm. Determining the first optimal order in which to operate on the set of objects may be based on packaging types and shapes of the individual objects in the set of objects.

Determining the first optimal order in which to operate on the set of objects may include identifying a plurality of candidate picks of the individual objects in the set of objects, wherein each candidate pick specifies an action picking up a specific object at a specific location with a specific tool. Determining the first optimal order in which to operate on the set of objects may include scoring and ranking the candidate picks. Scoring and ranking may be based on a likelihood that each of the candidate picks will succeed. Scoring and ranking may include assigning a greater likelihood of success to picks that include picking up an object near a center of a surface of the object. Scoring and ranking may include assigning a greater likelihood of success to picks that include picking up an object near a center of gravity of the object. Scoring and ranking may include assigning a lesser likelihood of success to picks that include picking up an object at a location that overlaps with other objects. Scoring and ranking may include assigning a lesser likelihood of success to picks that include picking up an object at a location that includes identifying information.

Determining the first optimal order in which to operate on the set of objects may be based on a likelihood that each of the picks will reveal additional information regarding the set of objects. Determining the first optimal order in which to operate on the set of objects may be based on a likelihood that each of the picks will change the collected information regarding the set of objects. The first optimal order or the second optimal order may be determined using a learning algorithm that processes historical information regarding the set of objects.

A robotic system may be summarized as comprising: a robotic arm having a distal end; a tool changer having a proximal end, the proximal end of the tool changer coupled to the distal end of the robotic arm, and a distal end, the distal end of the tool changer including a proximal engagement plate; and a tool having a proximal end, the proximal end of the tool including a distal engagement plate coupled to the proximal engagement plate of the tool changer; wherein the tool changer includes a proximal magnet embedded within the proximal engagement plate and the tool includes a distal magnet embedded within the distal engagement plate, wherein the proximal magnet is engaged with the distal magnet. A distal end of the proximal engagement plate may include a recess that has an overall shape comprising a truncated circular cone and a proximal end of the distal engagement plate may have an overall shape comprising a truncated circular cone.

### BRIEF DESCRIPTION OF THE SEVERAL VIEWS OF THE DRAWINGS

FIG. 1 illustrates a perspective view of a tool changer for a robotic arm.

FIG. 2 illustrates another perspective view of the tool changer of FIG. 1.

FIG. 3 illustrates another perspective view of the tool changer of FIG. 1.

FIG. 4 illustrates a housing component of the tool changer of FIG. 1.

FIG. 5 illustrates proximal engagement components of the tool changer illustrated in FIG. 1.

FIG. 6 illustrates a proximal engagement plate of the tool changer illustrated in FIG. 1.

FIG. 7 illustrates a magnet and a mechanical fastener of the tool changer illustrated in FIG. 1.

FIG. 8 illustrates distal engagement components of a tool configured to engage with the proximal engagement components of FIG. 5.

FIG. 9 illustrates a distal engagement plate of the distal engagement components of FIG. 8 that is configured to engage with the proximal engagement plate of FIG. 6.

FIG. 10 illustrates a perspective view of a tool holder for use with the tool changer illustrated in FIG. 1.

FIG. 11 illustrates a top view of the tool holder of FIG. 10.

FIG. 12 illustrates a method of operating a robotic system including a robotic arm, a tool changer, and a tool.

FIG. 13 illustrates a computer system.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

References to the term “set” (e.g., “a set of items”), as used herein, unless otherwise noted or contradicted by context, is to be construed as a nonempty collection comprising one or more members or instances.

As used herein, the terms “proximal” and “distal” carry their ordinary meanings with respect to a robotic arm system, unless the context dictates otherwise. For example, “proximal” generally means closer, along the length of the robotic arm system, to the base of the robotic arm system that is mounted rigidly to a floor or other rigid object, and “distal” generally means further, along the length of the robotic arm system, from the base of the robotic arm system.

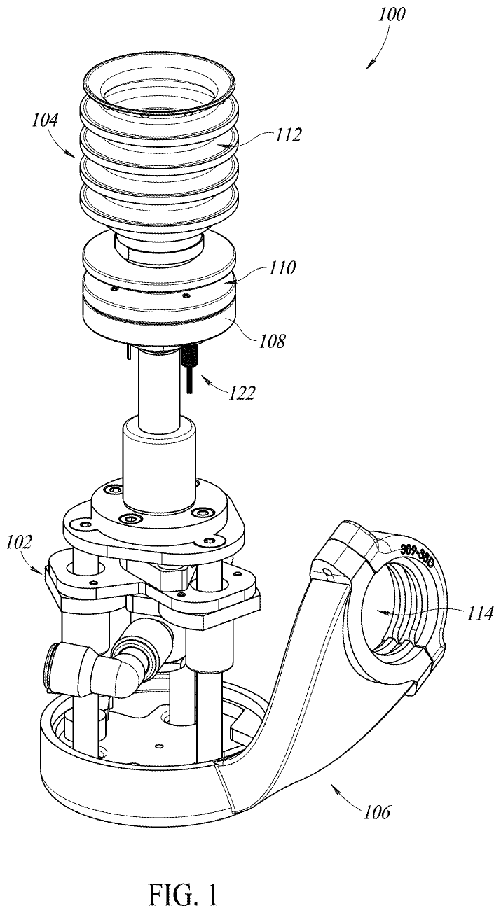

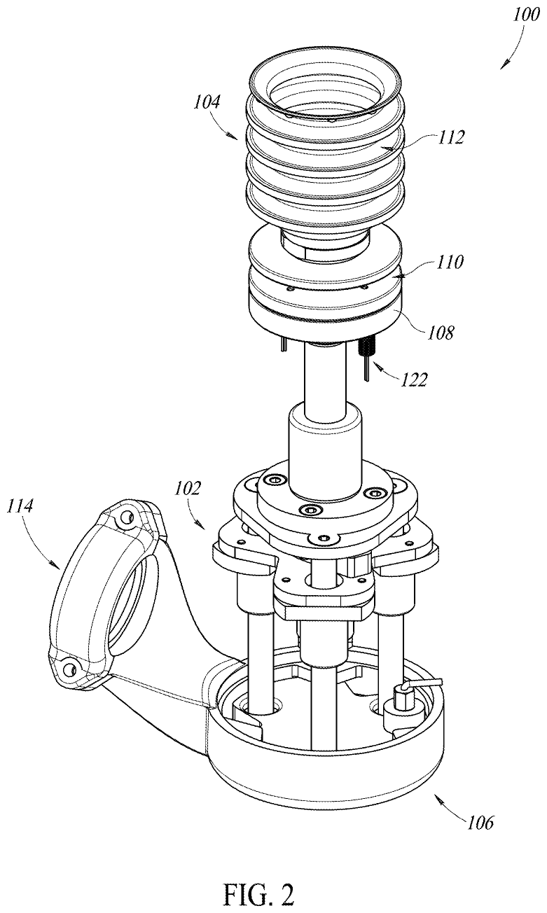

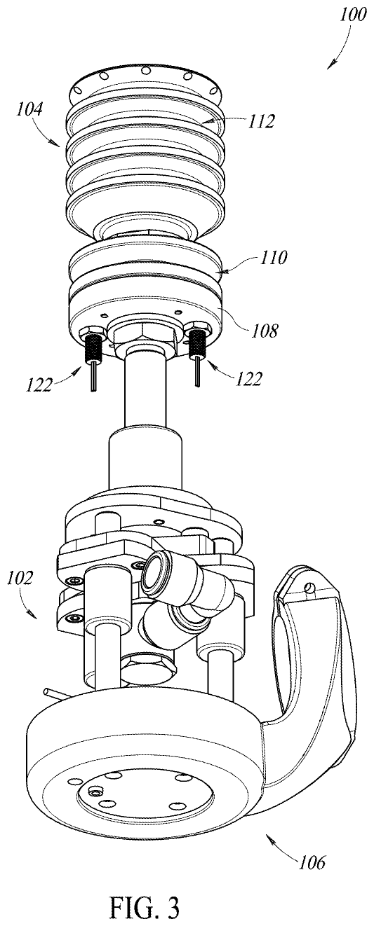

FIGS. 1-3 illustrate a system 100 including a tool changer 102 and an end of arm tooling (EOAT) or tool 104 for use with a robotic arm. The system 100 includes the tool changer 102, which forms a proximal portion of the system 100, which is configured to be coupled at a proximal end thereof to a terminal distal end of a standard, commercially-available robotic arm, and which is configured to be coupled at a distal end thereof opposite its proximal end to any one of a variety of different tools or other end-of-arm tooling (EOAT) devices, such as the tool 104. The tool changer 102 can be configured to couple each of the variety of different tools to the robotic arm, such as one at a time or in turn. For example, the tool changer 102 can be disconnected or decoupled from the tool 104 and connected or coupled to a different tool for use once operation of the tool 104 is complete. The tool changer 102 is also configured to perform other functions relevant to the operation of the tools coupled thereto, including the tool 104.

The system 100 includes the tool 104, which forms a distal portion of the system 100, which is configured to perform work or operate on a workpiece within a work environment of the robotic arm, and which is configured to be coupled at a proximal end thereof to the distal end of the tool changer 102, and thereby to the standard, commercially-available robotic arm. The tool 104 is configured to be coupled or connected to the distal end of the tool changer 102 and to be uncoupled or disconnected from the distal end of the tool changer 102, such as to allow a different tool to be coupled thereto. The tool 104 is a suction-based gripper configured to grasp and/or manipulate a workpiece by applying suction to a generally planar surface thereof. In some implementations, the tool 104 and the pneumatics supporting the tool 104 may be configured to apply a negative pressure of at least 4 or at least 5 bar (with respect to atmospheric pressure) and may be configured to provide a pneumatic flow rate of air of at least 5 standard cubic feet per minute.

The other, different tools referred to herein may include any type of tool known in the art, such as mechanical robotic grippers or fingers, 2-jaws, 3-jaws, collet and expanding mandrels, O-rings, needles, multiple fingers, adaptive fingers, bellows, bladders, electromagnets and magnets, electrostatic force devices, anthropomorphic hands with articulated fingers and palms, screwdrivers, hammers, saws, mallets, wrenches, and sensors, such as cameras and imaging devices, thermal sensors, weight sensors and strain gauges, and may be fluidly connected to a gas, liquid, paint, or other material that can be sprayed, applied, coated, and the like, onto a workpiece. In some implementations, the tool 104 may have a barcode, quick-response (QR) code, matrix code, serial number, or other identifier printed or affixed to an exterior thereof, such that the robotic arm or a camera or scanner coupled thereto can capture an image of the identifier so that the tool 104 affixed to the end of the tool changer 102 can be identified and distinguished from other tools to be used with the tool changer 102.

As illustrated in FIGS. 1-3, the tool changer 102 includes a portion of a housing 106 at the proximal end thereof, which is configured to be coupled directly to the robotic arm, and which is described in greater detail elsewhere herein. FIGS. 1-3 also illustrate that the tool changer 102 includes a proximal engagement plate 108 which is configured to engage with and be coupled to a complementary distal engagement plate of the tool 104, and which is described in greater detail elsewhere herein. FIGS. 1-3 also illustrate that the tool 104 includes a distal engagement plate 110 which is configured to engage with and be coupled to the proximal engagement plate 108 of the tool changer 102, and which is described in greater detail elsewhere herein. FIGS. 1-3 also illustrate that the tool 104 includes a bellows-type suction cup 112, which is configured to engage with and be coupled via suction to a workpiece being operated on by the tool 104.

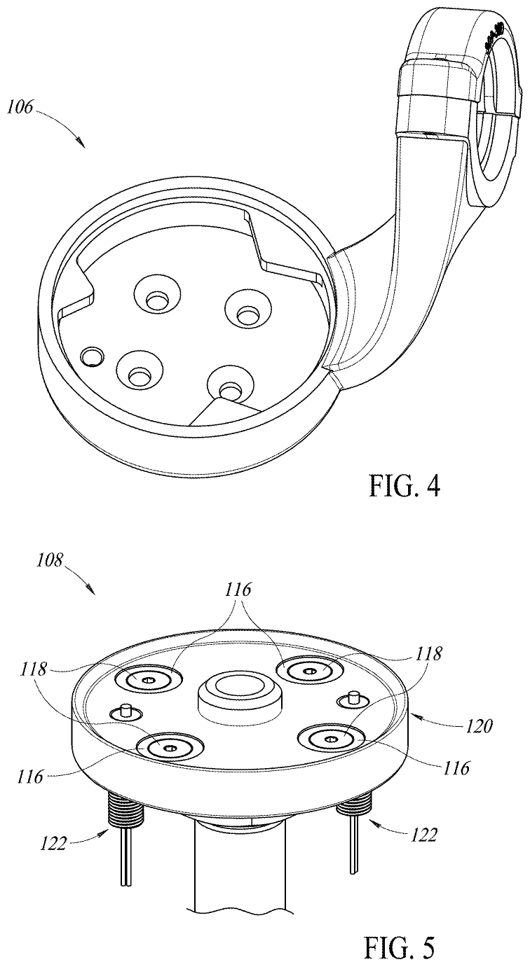

FIG. 4 illustrates a perspective view of the portion of the housing 106 of the tool changer 102 separated from the rest of the tool changer 102 and at a larger scale than in FIGS. 1-3. As illustrated in FIG. 4, the portion of the housing 106 includes a planar end wall at a proximal end thereof, which is configured to bear directly against and engage directly with a complementary bearing surface of the robotic arm to which the tool changer 102 is coupled. As further illustrated in FIG. 4, the planar end wall of the portion of the housing 106 includes a pattern of bolt holes arranged therein, where the pattern of bolt holes may correspond to, match, or complement a pattern of bolt holes in the bearing surface of the robotic arm. Such a pattern may be specified by the manufacturer of the robotic arm, such as by FANUC or ABB. The portion of the housing 106, and the rest of the tool changer 102 and the tool 104, may therefore be rigidly coupled to the robotic arm by a set of bolts extending through these bolt holes and into the terminal distal end of the robotic arm.

As further illustrated in FIG. 4, the portion of the housing 106 includes a circular opening or aperture 114. When the tool changer 102 is coupled to the robotic arm and in use, a conduit or other tube can be secured within and extend through the aperture 114. Such a conduit may carry cables, wires, or other conduits from outside of the tool changer 102 to inside of the tool changer 102. For example, such a conduit may carry a plurality of electronic cables, such as to provide power and/or communications capabilities for the tool changer 102 and/or the tool 104. As another example, such a conduit may also carry a plurality of hydraulic and/or pneumatic conduits, such as to provide power and/or communications capabilities for the tool changer 102 and/or the tool 104. Thus, such a conduit may enclose and protect such cables and/or conduits, and may be secured in position within the aperture 114 to ensure that the cables and/or conduits carried therein do not interfere with operation of the robotic arm, the tool changer 102, and/or the tool 104.

FIG. 5 illustrates proximal engagement components of the tool changer 102. As illustrated in FIG. 5, the tool changer 102 includes the proximal engagement plate 108, which is configured to engage with and be coupled to the complementary distal engagement plate 110 of the tool 104. As further illustrated in FIG. 5, the proximal engagement plate 108 includes a plurality of, e.g., four, magnets 116 embedded in the distally-facing surface thereof and secured thereto by a respective plurality of screws or other fasteners 118. In some embodiments, the magnets 116 may be permanent magnets, ferromagnetic, electromagnets, or any other type of magnet known in the art. As illustrated in FIG. 5, the plurality of magnets 116 and the respective screws 118 may be equally spaced apart from one another about a center of the proximal engagement plate 108, e.g., such that the magnets 116 are arranged in a square shape with a geometric center thereof at a center of the proximal engagement plate 108.

As further illustrated in FIG. 5, the proximal engagement plate 108 has an overall circular shape when viewed along a proximal-distal axis and an overall cylindrical outer profile, such that a diameter of an outer surface of the proximal engagement plate 108 is constant or substantially constant along a length or thickness of the proximal engagement plate 108. At an outer periphery or edge of the overall circular shape of a distally-facing end surface of the proximal engagement plate 108, the proximal engagement plate 108 includes a raised rim 120 that extends all the way around the circular shape of the proximal engagement plate 108 and that bounds or extends completely around the portion of the proximal engagement plate 108 within which the magnets 116 are embedded. As illustrated in FIG. 5, when the raised rim 120 is seen in a cross-sectional view of the proximal engagement plate 108, the raised rim 120 has an outer surface flush or coincident with the overall cylindrical outer profile of the proximal engagement plate 108 as a whole, and a sloped inner surface that extends at a slope or an angle inwardly from the outer surface toward the planar surface within which the magnets 116 are embedded. Thus, the distal end of the proximal engagement plate 108 has a recess formed therein that has an overall shape comprising a truncated circular cone.

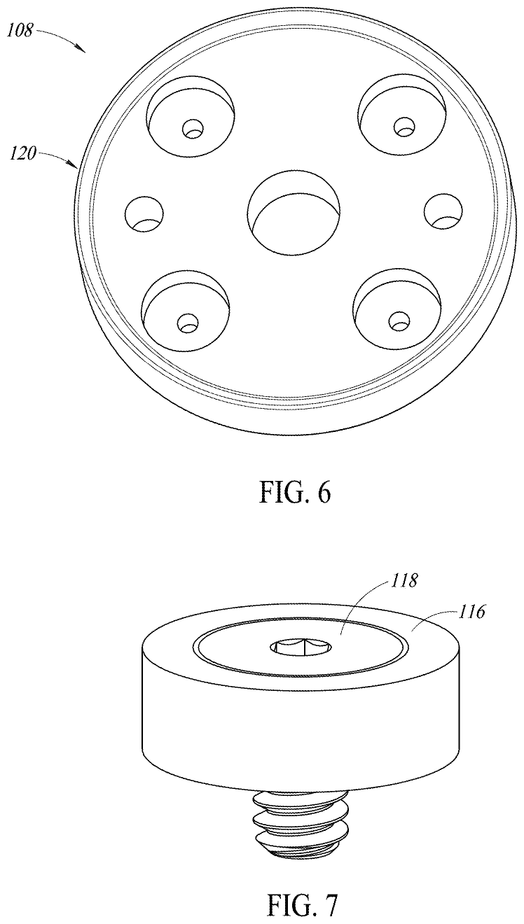

As further illustrated in FIG. 5, the tool changer 102 includes a pair of contact sensors 122 that extend through the proximal engagement plate 108 from a proximal surface thereof to a distal surface thereof. In some embodiments, the contact sensors 122 may have respective buttons in terminal distal ends thereof that can be depressed when in contact with another object to generate a signal indicating that the contact sensor 122 is in contact with another object. FIG. 6 illustrates the proximal engagement plate 108 with other components removed to reveal recesses for receiving the magnets 116 and the screws 118 and apertures for receiving the contact sensors 122. FIG. 7 illustrates one of the magnets 116 and one of the screws 118 separated from the rest of the components of the proximal engagement plate 108 to illustrate additional features thereof.

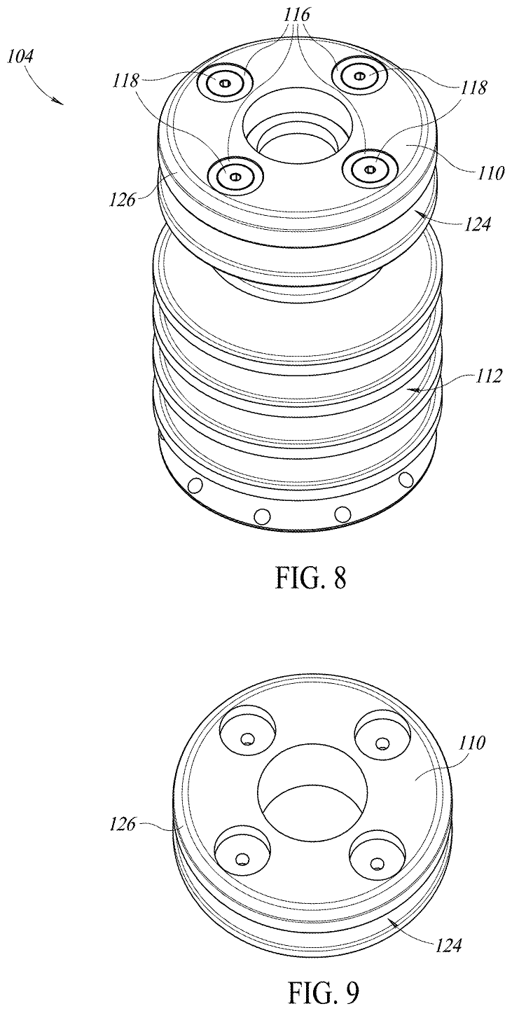

FIG. 8 illustrates the tool 104 and distal engagement components of the tool 104. As illustrated in FIG. 8, the tool 104 includes the distal engagement plate 110, which is configured to engage with and be coupled to the complementary proximal engagement plate 108 of the tool changer 102. As further illustrated in FIG. 8, the tool 104 includes a plurality of, e.g., four, magnets 116 embedded in the proximally-facing surface thereof and secured thereto by a respective plurality of screws or other fasteners 118. In some embodiments, the magnets 116 may be permanent magnets, ferromagnetic, electromagnets, or any other type of magnet known in the art. As illustrated in FIG. 8, the plurality of magnets 116 and the respective screws 118 may be equally spaced apart from one another about a center of the distal engagement plate 110, e.g., such that the magnets 116 are arranged in a square shape with a geometric center thereof at a center of the distal engagement plate 110. The square shape of the arrangement of the magnets 116 of the distal engagement plate 110 may correspond to or be the same as the square shape of the arrangement of the magnets 116 of the proximal engagement plate 108.

As further illustrated in FIG. 8, the distal engagement plate 110 has an overall circular shape when viewed along a proximal-distal axis and an overall cylindrical outer profile, such that a diameter of an outer surface of the distal engagement plate 110 is constant or substantially constant along a length of the distal engagement plate 110, except that the distal engagement plate 110 includes a circumferential groove 124 that extends inward into the otherwise cylindrical outer surface thereof. At an outer periphery or edge of the overall circular shape of a distally-facing end surface of the distal engagement plate 110, the distal engagement plate 110 includes a chamfered corner 126 that extends all the way around the circular shape of the distal engagement plate 110 and that bounds or extends completely around the portion of the distal engagement plate 110 within which the magnets 116 are embedded. Thus, the proximal end of the distal engagement plate 110 has an overall shape comprising a truncated circular cone. FIG. 9 illustrates the distal engagement plate 110 with other components removed to reveal recesses for receiving the magnets 116 and the screws 118.

In some embodiments, a tool such as the tool 104 may include flexibility or compliance or compliant elements on the gripping or other contact surfaces thereof, in order to accommodate any tolerances. For example, such features may allow a tool to compensate for depth errors and mitigate damage to workpieces. Such compliant elements may be made from flexible and soft (or partially soft) components, and can include materials selected from, but not limited to, cushions, foam, rubber, elastomers, silicone, and the like. In other embodiments, such compliant elements may be inflatable, Tillable, and/or expandable, so that their size, stiffness and/or dimensions can be variable and controlled via a pneumatic, hydraulic, gas, or fluid pump. For example, the system can determine, via reinforcement or recursive learning (“RL”), machine learning (“ML”), or any other learning mechanisms or techniques, including any algorithm, system, or process that incorporates reinforcement learning, recursive learning, machine learning, artificial intelligence, fuzzy logic, neural networks, and the like, that the tool requires a specific stiffness or deformability in order to optimally grasp certain workpieces. Such compliant elements can therefore be adjusted as needed.

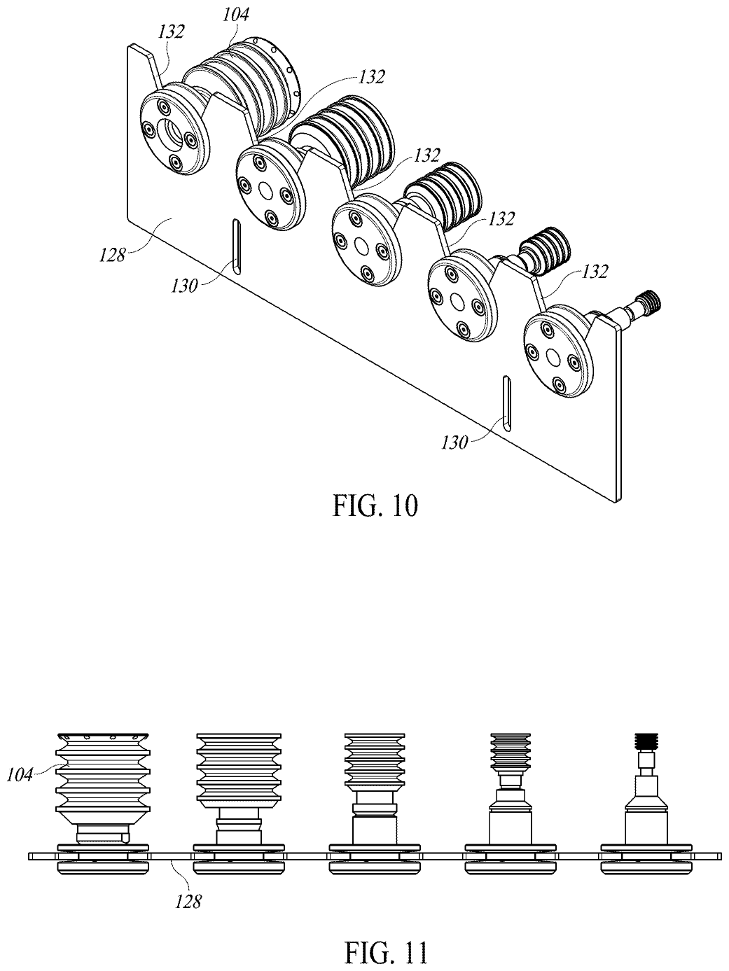

FIGS. 10 and 11 illustrate perspective and top views, respectively, of a tool holder 128 with five different tools held therein. As illustrated in FIGS. 10 and 11, the tool holder 128 may comprise a single sheet of material, such as a single piece of sheet metal, with a pair of apertures or bolt holes 130 formed therein. When the tool holder 128 is in use, bolts or other fasteners can extend through the bolt holes 130 to couple the tool holder 128 to other structures and hold the tool holder 128 in place and/or move the tool holder 128 around within the workspace of the robotic arm. As further illustrated in FIGS. 10 and 11, the tool holder 128 also has a plurality of (e.g., five in the illustrated embodiment) notches 132 formed in a top edge thereof, which can be configured to receive, support, and carry respective tools, including the tool 104, for use with the tool changer 102.

In some embodiments, a workspace for the robotic arm may include multiple tool holders each having the features described herein for the tool holder 128, which may be optimally placed in various locations around the workspace of the robotic arm, such that the robotic arm can quickly and easily reach a tool holder when needed, without requiring significant travel time. In another embodiment, the tool holders themselves can be mounted on separate robotic arms, conveyor belts, tracks, etc., in which case the tool holders can be moved to the robotic arm. In yet other embodiments, both the robotic arm and the tool holders can be movable so that such devices can be moved toward one another in a quick and efficient manner. In some embodiments, the robotic arm can include an integral tool holder including the features described herein for the tool holder 128. A tool may be selectively deployed and retracted from such a tool holder 128 as needed. In such embodiments, the tool holder 128 may be detachable from the robotic arm such that it can be replaced. For example, a first tool holder may be configured to hold a plurality of different suction-type tools (e.g., suction-type tools of different sizes or capacities), and a second tool holder may be configured to hold a plurality of different finger- or jaw-type tools (e.g., finger- or jaw-type tools of different sizes or capacities).

In a method of using the tool changer 102, the tool 104 and a plurality of additional tools, each of which may include any of the features described herein, may be initially mounted on the tool holder 128. For example, the tool 104 may be mounted on the tool holder 128 with the circumferential groove 124 engaged with the side surfaces or edges of the piece of sheet metal of the tool holder 128 adjacent to one of the notches 132.

Thus, the tool 104 can be held in one of the notches 132 of the tool holder 128 by gravity and can be removed from the notch 132 of the tool holder 128 in a straightforward manner, such as by raising the tool 104 upward with respect to the tool holder 128. The robotic arm to which the tool changer 102 is coupled may manipulate the tool changer 102 until the distal end surface of the proximal engagement plate 108 engages with the proximal end surface of the distal engagement plate 110, such that the magnets 116 embedded in the proximal engagement plate 108 engage with the magnets 116 embedded in the distal engagement plate 110, such that the truncated circular cone of the distal engagement plate is seated within the truncated circular cone-shaped recess at the end of the proximal engagement plate, which can auto-center the tool 104 onto the tool changer 102, and such that the contact sensors 122 are activated.

The robotic arm may then manipulate the tool changer 102 and the tool 104 coupled thereto to perform work on one or more workpieces within a workspace of the robotic arm, until such operations with the tool 104 are complete. The robotic arm may then manipulate the tool changer 102 and the tool 104 until the tool 104 is seated once again on the tool holder 128. The robotic arm may then manipulate the tool changer 102 until the distal end surface of the proximal engagement plate 108 engages with the proximal end surface of a distal engagement plate of another one of the tools, and then manipulate the tool changer 102 and the tool coupled thereto to perform work on one or more workpieces within a workspace of the robotic arm, until such operations with the tool are complete. The robotic arm may then manipulate the tool changer 102 and the tool until the tool is seated once again on the tool holder 128. Such operations may be repeated until all operations to be performed are complete. In some implementations, the features described herein are capable of changing a tool coupled to the tool changer 102 at an average rate of at least once every two seconds.

A method of operating a robotic arm, the tool changer 102, and a plurality of tools including the tool 104 may include selecting tools for use in operating on workpieces within a workspace on-the-fly, or updating an order in which the tools are to be used based on information received after a first one of the tools is used to operate on a first workpiece in the workspace. For example, a sorting system including the robotic arm, the tool changer 102, and the plurality of tools including the tool 104 can include various sensors, including weight sensors, transducers, imaging systems, cameras, scanners, etc., which can be used to capture and record information regarding the workspace within which the system is operating and a variety of workpieces therein, such as to detect and identify the various workpieces in the workspace, which may be objects to be sorted from within a sorting bin, to detect an object class or type for each of the workpieces, to detect a packaging type or class for each of the workpieces, to detect a material type or class for each of the workpieces, and/or to detect a porosity of each of the workpieces or the packaging for each of the workpieces.

Such information may be used to assess and evaluate the efficiency of using the tools in different orders, and such information may be updated after every operation on one of the workpieces in the workspace to refine or change the order in which the tools are to be used. For example, the system may use the sensors to collect information regarding an initial state of a plurality of workpieces within the workspace. This may include identifying workpieces that may be picked up by a suction gripper (e.g., rigid objects with planar surfaces), a finger gripper (e.g., flexible objects stored within polybags), or another tool, as well as workpieces that cannot be picked up or that are difficult to pick up, or that are otherwise to be avoided. The system may then use the information provided by the sensors to identify ways in which the workpieces could be picked up by a tool such as a suction gripper or a finger gripper, which may include identifying locations on a rigid workpiece to which a suction gripper could be affixed or locations on a flexible workpiece by which a set of finger grippers could grasp the workpiece.

The sorting system may then identify candidate “picks” of the workpieces, where a “pick” is an action of picking up a workpiece at a specific location with a specific tool, and then scoring and/or ranking the “picks,” such as based on how likely they are to succeed. Such scoring may assign greater likelihood of success to picks that include picking up a workpiece near a center of a surface of the workpiece and/or near a center of gravity of the workpiece, and may assign a lesser likelihood of success to picks that include picking up a workpiece at a location that overlaps with other workpieces or that includes a barcode or other text or identifying information for the workpiece. From the identified candidate picks, the system may then calculate or otherwise determine an optimal or most efficient order in which to execute the picks, which may be based at least in part on the movements of the robotic arm needed to execute the picks in each potential order, the number of tool changes needed to execute the picks in each potential order, and the movements of the robotic arm needed to stow (that is, release in an intended destination) each object once successfully picked. As one example, the system may recognize that it can be more efficient to continue operating with a current tool even after the candidate picks to be executed with that tool are poorly-scored, because switching tools is costly.

If the system determines that a first order in which the picks can be executed, and therefore a first order in which the tools can be used, is the optimal or most efficient order, based on the information provided by the sensors, then the system may begin by coupling a first one of the tools, such as the tool 104, to the tool changer 102, and begin operating on the workpieces in the work space using the tool 104 in the determined order. Such operations may, however, change the environment in a way that changes the optimal or most efficient order in which the picks can be executed and the tools can be used. For example, if the tool 104 is used to move a first workpiece, movement of the first workpiece may reveal other workpieces that were previously obscured or blocked by the first workpiece, or information regarding such workpieces that was not previously available. In such a situation, there may be new potential picks to evaluate and incorporate into the system's future operations, and the optimal order in which the picks can be executed and in which the tools can be used may change or be updated accordingly.

As another example, if the tool 104 is used to move a first workpiece, movement of the first workpiece may incidentally move other workpieces, or otherwise change the state of the collection of workpieces to be sorted by the system. In such a situation, there may be new potential picks to evaluate and incorporate into the system's future operations, and/or previously-identified and scored picks may no longer exist, and the optimal order in which the picks can be executed and in which the tools can be used may change or be updated accordingly. In some implementations, the system may be able to determine in advance of an operation or a set of operations that the operations have a likelihood of revealing additional workpieces or portions thereof, or additional information regarding the workpieces, or of moving additional workpieces or otherwise changing the environment. In such a situation, the system may use such information in advance in its determination of the optimal or most efficient order of operating on the workpieces and/or using the tools.

In one further example, additional objects to be sorted may be supplied to the workspace of the robotic arm after one or more picks have been performed. In such a situation, there will be new potential picks to evaluate and incorporate into the system's future operations, and/or previously-identified and scored picks may no longer exist, and the optimal order in which the picks can be executed and in which the tools can be used may change or be updated accordingly.

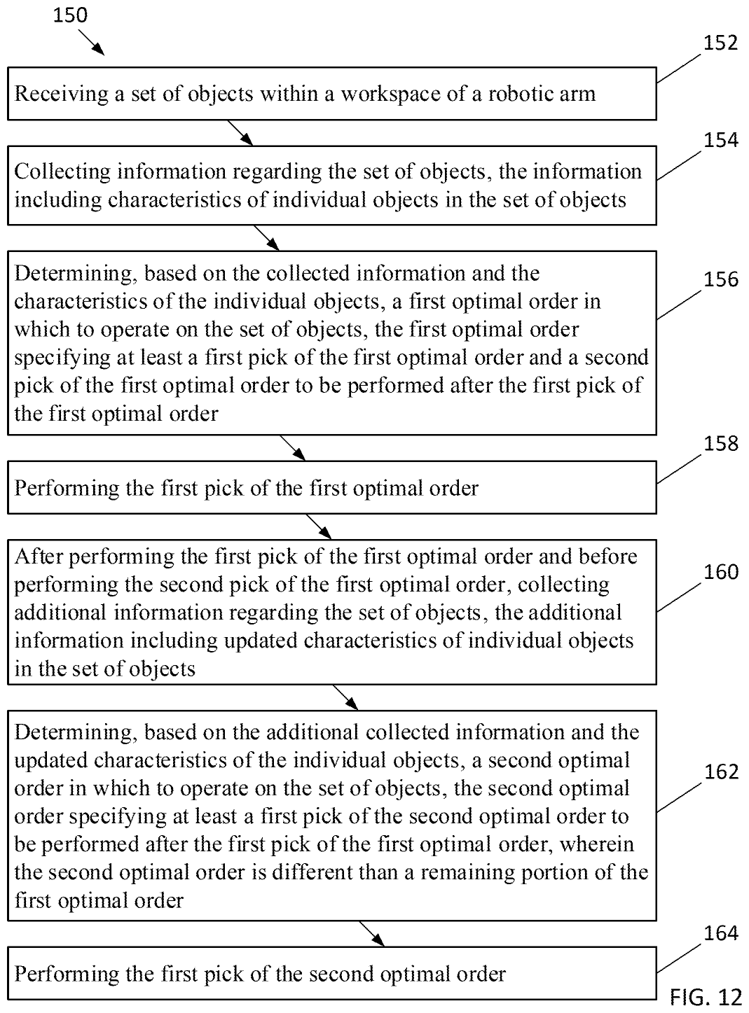

FIG. 12 illustrates one example of a method 150 of operating a robotic sorting system including a robotic arm, a tool changer, and a plurality of tools. For example, the method 150 may include, at 152, receiving a set of objects within a workspace of a robotic arm, and at 154, collecting information regarding the set of objects, the information including characteristics of individual objects in the set of objects. The method may further include, at 156, determining, based on the collected information and the characteristics of the individual objects, a first optimal order in which to operate on the set of objects, the first optimal order specifying at least a first pick of the first optimal order and a second pick of the first optimal order to be performed after the first pick of the first optimal order. The method may further include, at 158, performing the first pick of the first optimal order. The method may further include, at 160, after performing the first pick of the first optimal order and before performing the second pick of the first optimal order, collecting additional information regarding the set of objects, the additional information including updated characteristics of individual objects in the set of objects. The method may further include, at 162, determining, based on the additional collected information and the updated characteristics of the individual objects, a second optimal order in which to operate on the set of objects, the second optimal order specifying at least a first pick of the second optimal order to be performed after the first pick of the first optimal order, wherein the second optimal order is different than a remaining portion of the first optimal order. Finally, the method may further include, at 164, performing the first pick of the second optimal order.

In some implementations, the system can be used in conjunction with reinforcement or recursive learning (“RL”), other machine learning (“ML”) or artificial intelligence, or any other learning mechanisms or techniques, including any algorithm, system, or process that incorporates reinforcement learning, recursive learning, machine learning, artificial intelligence, fuzzy logic, neural networks, and the like, so that over time, the system can intelligently predict an EOAT change based on when a particular type, size, or shape of object is present in a bin, and proactively instruct the robotic arm to make an EOAT change on-the-fly, reducing downtime and improving efficiency of the system. In addition, over time, the system can track data related to the usage of various different EOATs, and the corresponding objects or item types that each EOAT was used for in the past, in order to determine the ideal/optimal EOAT to use for each object in the future.

In another embodiment, the RL and ML techniques can be used to segment different types of objects in a bin. The system can identify different groups of objects, based on their characteristics (i.e., size, weight, dimensions, materials, etc.). The system can then instruct the robotic arm to sort/manipulate all items that can be handled by a specific EOAT (i.e., for example, square polybags or non-rigid objects). Once those items have been handled, then robotic arm may be instructed to replace the EOAT, and then sort/manipulate another group of items that require a different EOAT (i.e., for example, rectangular boxes or rigid objects). Thus, the system can identify objects based on the required EOAT, and subsequently efficiently utilize the appropriate EOAT to intelligently handle (i.e., stow, transport, move, etc.) those objects.

The systems described herein can be used in a sorting, scanning, and/or pick-and-place environment, and may be implemented within a retail supply chain warehouse, where the objects include apparel, consumer goods, merchandise, and the like. However, embodiments of the present invention are not intended to be limited to a retail supply chain setting, and can be utilized in various environments, such as in assembly lines, goods processing facilities, equipment manufacturing facilities , robotic surgery systems, and the like, and the objects handled by the tools described herein may include tools, packages, letters, currency, foodstuffs, biological material, semiconductors, consumer electronics, hazardous materials, building materials, automotive components, and the like.

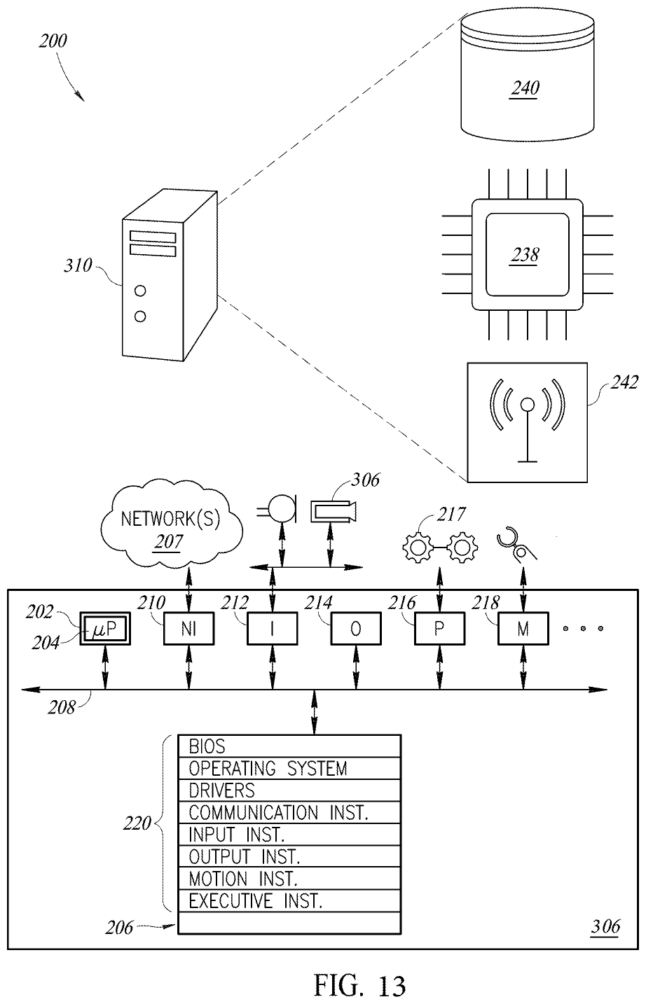

FIG. 13 shows a schematic diagram 200 of a computer system 310 and a robotic system 306, which may include any of the features described herein. The robotic system 306 may include a control subsystem 202 that includes at least one processor 204, at least one non-transitory tangible computer- and processor-readable data storage 206, and at least one bus 208 to which the at least one processor 204 and the at least one non-transitory tangible computer- or processor-readable data storage 206 are communicatively coupled.

The at least one processor 204 may be any logic processing unit, such as one or more microprocessors, central processing units (CPUs), digital signal processors (DSPs), graphics processing units (GPUs), application-specific integrated circuits (ASICs), programmable gate arrays (PGAs), programmed logic units (PLUs), and the like. At least one processor 204 may be referred to herein by the singular, but may be two or more processors.

The robotic system 306 may include a communications subsystem 210 communicatively coupled to (e.g., in communication with) the bus(es) 208 and provides bi-directional communication with other systems (e.g., systems external to the robotic system 306) via a network or non-network communication channel, such as one or more network(s) 207 described herein. The communications subsystem 210 may include one or more buffers. The communications subsystem 210 receives and sends data for the robotic system 306, such as sensory information and actuation information. The one or more networks 207 may include wired and/or wireless networks, a local area network (LAN), a mesh network, or other network suitable to convey medications and information described herein. In some embodiments, the computer system 310 and the robotic system 306 may not communicate over the one or more networks 207.

The communications subsystem 210 may be any circuitry effecting bidirectional communication of processor-readable data, and processor-executable instructions, for instance radios (e.g., radio or microwave frequency transmitters, receivers, transceivers), communications ports and/or associated controllers. Suitable communication protocols include FTP, HTTP, Web Services, SOAP with XML, WI-FI compliant, BLUETOOTH compliant, cellular (e.g., GSM, CDMA), and the like.

Robotic system 306 may include an input subsystem 212. In any of the implementations, the input subsystem 212 can include one or more sensors that measure conditions or states of robotic system 306, and/or conditions in the environment in which the robotic system 306 operates. Such sensors include cameras or other imaging devices (e.g., responsive in visible and/or nonvisible ranges of the electromagnetic spectrum including for instance infrared and ultraviolet), radars, sonars, touch sensors, pressure sensors, load cells, microphones, meteorological sensors, chemical sensors, or the like. Such sensors include internal sensors, pressure sensors, load cells, strain gauges, vibration sensors, microphones, ammeter, voltmeter, or the like. In some implementations, the input subsystem 212 includes receivers to receive position and/or orientation information. For example, a global position system (GPS) receiver to receive GPS data, two more time signals for the control subsystem 202 to create a position measurement based on data in the signals, such as, time of flight, signal strength, or other data to effect (e.g., make) a position measurement. Also, for example, one or more accelerometers, gyroscopes, and/or altimeters can provide inertial or directional data in one, two, or three axes. In some implementations, the input subsystem 212 includes receivers to receive information that represents posture. For example, one or more accelerometers or one or more inertial measurement units can provide inertial or directional data in one, two, or three axes to the control subsystem 202 to create a position and orientation measurements. The control subsystem 202 may receive joint angle data from the input subsystem 212 or the manipulation subsystem described herein.

Robotic system 306 may include an output subsystem 214 comprising output devices, such as, speakers, lights, and displays. The input subsystem 212 and output subsystem 214, are communicatively coupled to the processor(s) 204 via the bus(es) 208.

Robotic system 306 may include a propulsion or motion subsystem 216 comprising motive hardware 217, such as motors, actuators, drivetrain, wheels, tracks, treads, and the like to propel or move the robotic system 306 within a physical space and interact with it. The propulsion or motion subsystem 216 may comprise of one or more motors, solenoids or other actuators, and associated hardware (e.g., drivetrain, wheel(s), treads), to propel robotic system 306 in a physical space. For example, the propulsion or motion subsystem 216 may include a drive train and wheels, or may include legs independently operable via electric motors. Propulsion or motion subsystem 216 may move the body of the robotic system 306 within the environment as a result of motive force applied by the set of motors.

Robotic system 306 may include a manipulation subsystem 218, for example comprising one or more arms, end-effectors, associated motors, solenoids, other actuators, gears, linkages, drive-belts, and the like coupled and operable to cause the arm(s) and/or end-effector(s) to move within a range of motions. For example, the manipulation subsystem 218 causes actuation of the robotic arm or other device for interacting with objects or features in the environment. The manipulation subsystem 218 is communicatively coupled to the processor(s) 204 via the bus(es) 208, which communications can be bi-directional or uni-directional.

Components in robotic system 306 may be varied, combined, split, omitted, or the like. For example, robotic system 306 could include a pair of cameras (e.g., stereo pair) or a plurality of microphones. Robotic system 306 may include one, two, or three robotic arms or manipulators associated with the manipulation subsystem 218. In some implementations, the bus(es) 208 include a plurality of different types of buses (e.g., data buses, instruction buses, power buses). For example, robotic system 306 may include a modular computing architecture where computational resources devices are distributed over the components of robotic system 306. In some implementations, a robot (e.g., robotic system 306), could have a processor in an arm and data storage in a body or frame thereof. In some implementations, computational resources are located in the interstitial spaces between structural or mechanical components of the robotic system 306.

The at least one data storage 206 includes at least one non-transitory or tangible storage device. The at least one data storage 206 can include two or more distinct non-transitory storage devices. The data storage 206 can, for example, include one or more a volatile storage devices, for instance random access memory (RAM), and/or one or more non-volatile storage devices, for instance read only memory (ROM), Flash memory, magnetic hard disk (HDD), optical disk, solid state disk (SSD), and the like. A person of skill in the art will appreciate storage may be implemented in a variety of non-transitory structures, for instance a read only memory (ROM), random access memory (RAM), a hard disk drive (HDD), a network drive, flash memory, digital versatile disk (DVD), any other forms of computer- and processor- readable memory or storage medium, and/or a combination thereof. Storage can be read only or read-write as needed. Further, volatile storage and non-volatile storage may be conflated, for example, caching, using solid-state devices as hard drives, in-memory data processing, and the like.

The at least one data storage 206 includes or stores processor-executable instructions and/or processor-readable data 220 associated with the operation of robotic system 306 or other devices. Here, processor-executable instructions and/or processor-readable data may be abbreviated to processor-executable instructions and/or data.

The execution of the processor-executable instructions and/or data 220 cause the at least one processor 204 to carry out various methods and actions, for example via the motion subsystem 216 or the manipulation subsystem 218. The processor(s) 204 and/or control subsystem 202 can cause robotic system 306 to carry out various methods and actions including receiving, transforming, and presenting information; moving in the environment; manipulating items; and acquiring data from sensors. Processor-executable instructions and/or data 220 can, for example, include a basic input/output system (BIOS) 222, an operating system 224, drivers 226, communication instructions and data 228, input instructions and data 230, output instructions and data 232, motion instructions and data 234, and executive instructions and data 236.

Exemplary operating systems 224 include ANDROID™, LINUX®, and WINDOWS®. The drivers 226 include processor-executable instructions and/or data that allow control subsystem 202 to control circuitry of robotic system 306. The processor-executable communication instructions and/or data 228 include processor-executable instructions and data to implement communications between robotic system 306 and an operator interface, terminal, a computer, or the like. The processor-executable input instructions and/or data 230 guide robotic system 306 to process input from sensors in input subsystem 212. The processor-executable input instructions and/or data 230 implement, in part, the methods described herein.

The processor-executable output instructions and/or data 232 guide robotic system 306 to provide information that represents, or produce control signal that transforms, information for display. The processor-executable motion instructions and/or data 234, as a result of execution, cause the robotic system 306 to move in a physical space and/or manipulate one or more items. The processor-executable motion instructions and/or data 234, as a result of execution, may guide the robotic system 306 in moving within its environment via components in propulsion or motion subsystem 216 and/or manipulation subsystem 218. The processor-executable executive instructions and/or data 236, as a result of execution, guide the robotic system 306 the instant application or task for devices and sensors in the environment. The processor-executable executive instructions and/or data 236, as a result of execution, guide the robotic system 306 in reasoning, problem solving, planning tasks, performing tasks, and the like.

The instructions 220, as a result of execution by the processor(s) 204, may cause the robotic system 306 to process the plurality of objects by successively extracting each object (i.e., as the object) from a designated area. The instructions 220 may further cause the processor(s) 204 to process input information received via the input subsystem 212, such as video data captured by a camera or measurements by one or more sensors, and recognize the presence of the plurality of objects located in the designated area based on the input information received. Instructions 220 may also cause the robotic system 306 to, while in possession of the object extracted, perform a set of movements and deposit the object in a certain location. In some embodiments, the robotic system 306 may, while in possession of the object extracted, receive a communication from the computer system 310 and deposit the object and a location indicated in the communication received. In some embodiments, the robotic system 306 operates independently of the computer system 310 when processing the plurality of objects and may deposit each object extracted in a predetermined area or location (e.g., conveyor belt, receptacle).

The computer system 310 includes one or more processors 238, memory 240, and a communication interface 242. The memory 240 is computer-readable non-transitory data storage that stores a set of computer program instructions that the one or more processors 238 may execute to implement one or more embodiments of the present disclosure. The memory 240 generally includes RAM, ROM and/or other persistent or non-transitory computer-readable storage media, such as magnetic hard drives, solid state drives, optical drives, and the like. The memory 240 may store an operating system comprising computer program instructions useable by the one or more processors 238 in the general administration and operation of the computer system 310.

The communication interface 242 includes one or more communication devices for transmitting communications and receiving communications via the network 207. The one or more communication devices of the communication interface may include wired communication devices and/or wireless communication devices. Non-limiting examples of wireless communication devices include RF communication adapters (e.g., Zigbee adapters, Bluetooth adapters, ultra-wideband adapters, Wi-Fi adapters) using corresponding communication protocols, satellite communication transceivers, free-space optical communication devices, cellular network transceivers, and the like. Non-limiting examples of wired communication devices include serial communication interfaces (e.g., RS-232, Universal Serial Bus, IEEE 139), parallel communication interfaces, Ethernet interfaces, coaxial interfaces, optical fiber interfaces, and power-line communication interfaces. The computer system 310 may transmit information via the communication interface 242 to the robotic system 306 or other robots, devices, machinery, etc., such as information indicating an operation to be performed involving an object or workpiece.

The computer system 310 and the robotic system 306 may communicate information over the one or more networks 207 regarding the operations described with respect to the environment. In some embodiments, the computer system 310 and the robotic system 306 may not communicate over the one or more networks 207. For example, the robotic system 306 may operate autonomously and independent of the computer system 310 to successively extract each of the plurality of objects from the designated area. The computer system 310 may detect or observe operations of the robotic system 306, e.g., via a camera and/or other sensors, and cause devices, machinery, or robots other than the robotic system 306, to perform operations involving each object extracted. As an example, the computer system 310 may detect an identifier of each object upon extraction and control a series of conveyors to deliver the object to a desired location corresponding to the identifier.

U.S. provisional patent application No. 62/874,721, filed Jul. 16, 2019, is hereby incorporated by reference in its entirety. The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving a set of objects within a workspace of a robotic arm;
collecting information regarding the set of objects, the information including characteristics of individual objects in the set of objects;
determining, based on the collected information and the characteristics of the individual objects, a first optimal order in which to operate on the set of objects, the first optimal order specifying at least a first pick of the first optimal order and a second pick of the first optimal order to be performed after the first pick of the first optimal order;
performing the first pick of the first optimal order;
after performing the first pick of the first optimal order and before performing the second pick of the first optimal order, collecting additional information regarding the set of objects, the additional information including updated characteristics of individual objects in the set of objects;
determining, based on the additional collected information and the updated characteristics of the individual objects, a second optimal order in which to operate on the set of objects, the second optimal order specifying at least a first pick of the second optimal order to be performed after the first pick of the first optimal order, wherein the second optimal order is different than a remaining portion of the first optimal order; and
performing the first pick of the second optimal order.

2. The method of claim 1 wherein the characteristics of the individual objects in the set of objects includes an object type of the individual objects.

3. The method of claim 1 wherein the characteristics of the individual objects in the set of objects includes dimensions of the individual objects.

4. The method of claim 1 wherein the characteristics of the individual objects in the set of objects includes locations of the individual objects.

5. The method of claim 1 wherein the characteristics of the individual objects in the set of objects includes orientations of the individual objects.

6. The method of claim 1 wherein the characteristics of the individual objects in the set of objects includes rigidities and porosities of the individual objects.

7. The method of claim 1 wherein determining the first optimal order in which to operate on the set of objects includes determining a first optimal order in which to use each of a plurality of different tools coupled to a distal end of the robotic arm.

8. The method of claim 1 wherein determining the first optimal order in which to operate on the set of objects is based on packaging types and shapes of the individual objects in the set of objects.

9. The method of claim 1 wherein determining the first optimal order in which to operate on the set of objects includes identifying a plurality of candidate picks of the individual objects in the set of objects, wherein each candidate pick specifies an action picking up a specific object at a specific location with a specific tool.

10. The method of claim 9 wherein determining the first optimal order in which to operate on the set of objects includes scoring and ranking the candidate picks.

11. The method of claim 10 wherein the scoring and ranking are based on a likelihood that each of the candidate picks will succeed.

12. The method of claim 10 wherein the scoring and ranking include assigning a greater likelihood of success to picks that include picking up an object near a center of a surface of the object.

13. The method of claim 10 wherein the scoring and ranking include assigning a greater likelihood of success to picks that include picking up an object near a center of gravity of the object.

14. The method of claim 10 wherein the scoring and ranking include assigning a lesser likelihood of success to picks that include picking up an object at a location that overlaps with other objects.

15. The method of claim 10 wherein the scoring and ranking include assigning a lesser likelihood of success to picks that include picking up an object at a location that includes identifying information.

16. The method of claim 1 wherein determining the first optimal order in which to operate on the set of objects is based on a likelihood that each of the picks will reveal additional information regarding the set of objects.

17. The method of claim 1 wherein determining the first optimal order in which to operate on the set of objects is based on a likelihood that each of the picks will change the collected information regarding the set of objects.

18. The method of claim 1 wherein the first optimal order or the second optimal order is determined using a learning algorithm that processes historical information regarding the set of objects.

19. A robotic system, comprising:
a robotic arm having a distal end;
a tool changer having a proximal end, the proximal end of the tool changer coupled to the distal end of the robotic arm, and a distal end, the distal end of the tool changer including a proximal engagement plate; and
a tool having a proximal end, the proximal end of the tool including a distal engagement plate coupled to the proximal engagement plate of the tool changer;
wherein the tool changer includes a proximal magnet embedded within the proximal engagement plate and the tool includes a distal magnet embedded within the distal engagement plate, wherein the proximal magnet is engaged with the distal magnet.

20. The robotic system of claim 19, wherein a distal end of the proximal engagement plate includes a recess that has an overall shape comprising a truncated circular cone and wherein a proximal end of the distal engagement plate has an overall shape comprising a truncated circular cone.
